(19) United States
(12) Patent Application Publication
(10) Pub. No.: US 2005/0050557 A1
(43) Pub. Date: Mar. 3, 2005

(54) Adaptive multiple concurrent CD/DVD streaming algorithms

(76) Inventors: Henry P. Gabryjelski, Seattle, WA (US); Daniel Rosenstein, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/650,633

(22) Filed: Aug. 28, 2003

(51) Int. Cl. G11B 7/085

(52) U.S. Cl. 720/600

(57) ABSTRACT

The subject invention provides for a system and method that facilitates concurrent data streaming. In particular, the invention involves initiating a first operation from the optical media at time tₓ and initiating at least a second operation from the optical media at time t_{y} while the first operation is currently in progress, wherein tₓ≠t_{y}. The first operation includes reading a real-time data stream to a first buffer. The second operation includes one of reading a real-time data stream and a non-real-time data stream to at least a second buffer. Furthermore, a utility-based analysis can be performed to determine whether to access the first buffer rather than to access the surface of the optical media in order to conduct the second operation. Moreover, the first and at least second operations can be performed in parallel.

### TECHNICAL FIELD

This invention is related to systems and methods for concurrent data streaming from the same optical media.

### BACKGROUND OF THE INVENTION

Over the past few years, computer technology has focused on faster processing speeds and increased performance levels. As processing speeds have amplified, so have users' demands for computer functionality. In addition to word processing and data storage, many users make use of their desktop and laptop computers for entertainment purposes, such as for playing video games, watching live video programs and movies, and listening to music from compact discs and live radio. As a result, video graphics and sound capabilities have dramatically improved to provide crystal clear imagery as well as stereo-quality sound.

Despite significant advancements in computer technology, some limitations still exist that can hinder a user's enjoyment and unnecessarily increase their time spent to complete various desired tasks on the computer. In particular, users are somewhat restricted by conventional technology with respect to streaming data from optical media.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

For the purposes of this description, real-time data streams are defined to be data streams where a given data rate per time period is required for a given use. Examples would be audio playback (176 kilobytes/second) or DVD-Video playback (10 megabits/second). Examples of non-real-time data streams would be “ripping” a CD audio track from the CD media onto the hard drive. The non-qualified term “data stream” shall be used when either of the above two types of data stream are applicable.

The subject invention provides for a system and method that facilitates reading multiple concurrent data streams from optical media (e.g., a compact disc (CD)). Traditional optical media processing algorithms do not allow for concurrent real-time streaming from optical media. For example, if a user wishes to move data to a hard drive from a compact disc (e.g., rip a compact disc) that he is currently listening to, the current playback process (real-time data stream) is interrupted and/or terminated as soon as the rip (non-real-time data stream) is initiated. Moreover, conventional hardware does not permit reading a second data stream from the media if an audio playback operation is currently in progress.

According to one aspect of the present invention, concurrent data streaming from optical media, including CDs and DVDs (digital video discs), can be accomplished in part by employing at least two buffers each associated with a respective data stream and each having a sufficient size and caching speed (e.g., speed at which recently-used data is cached or distributed to a memory that can be used to fill subsequent requests for the same information to spare the system from having to re-read it from the drive or other device) to allow for simultaneously ripping (e.g., recording; non-real-time data stream) and playing (e.g., listening; real-time data stream) of at least one audio data stream from the same optical media. Hence, an optical media drive (e.g., CD-ROM drive) is constantly seeking back and forth so that the non-real-time data stream can be performed even after the real-time data stream has begun.

Alternatively, the same could be accomplished while employing at least one buffer instead of two. For instance, a real-time data stream is being played from a compact disc. As the data is read from the disc, it is cached to the memory buffer, where it can be accessed more readily if desired in the near future. At some point while the data is playing for the user, the user decides to record the same stream of data to a long-term memory store. Instead of reading from the compact disc and employing a separate buffer to concurrently record the data, the memory buffer can be accessed and read to record therefrom. In other words, it may be more cost effective to access the data previously stored on the buffer rather than accessing the data from the original source: the compact disc. Hence, the data is recorded from the buffer to the long-term memory store rather than from the compact disc. In general, this can be accomplished in part by verifying that the data transfer rates and seek times of the optical media and that the relevant buffer are sufficient to allow for the concurrent operation of at least two data streams (e.g., at least one non-real-time data stream, at least one real-time data stream, and/or any combination thereof).

According to another aspect of the present invention, multiple streams of data can be accessed concurrently and/or simultaneously when multiple buffers are utilized. As a result, the user can play multiple tracks off of the same optical media and direct them to multiple outputs. For example, one track can be played in one's bedroom whereas a different track from the same source or disc can be played at about the same time on the patio.

Yet another aspect involves reading a non-real-time data stream from optical media (e.g. ripping a CD track), and then at some later point during the ripping, reading a real-time data stream (e.g., playing that CD track to speakers) without interrupting the existing non-real-time data stream reading.

Still another aspect involves reading a real-time data stream from optical media (e.g., playing a CD track), and then at some later point during the playing, reading a second real-time data stream (e.g. playing a second CD track) without interrupting the existing playback operation.

According to yet another aspect, the present invention involves reading a real-time data stream from optical media (e.g., playing a CD track), and then at some later point during the playing, reading a second non-real-time data stream (e.g., ripping a CD track) without interrupting the existing playback operation.

Moreover, the present invention provides for concurrent data streaming from optical media to facilitate and enhance a user's computer experience since many tasks that are typically performed serially can now be accomplished in parallel, thereby increasing overall efficiency.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a general block diagram of a system that facilitates concurrent data streaming in accordance with an aspect of the present invention.

FIG. 2 is a schematic diagram of concurrent data streaming in accordance with an aspect of the present invention.

FIG. 3 is a schematic diagram of concurrent data streaming in accordance with an aspect of the present invention.

FIG. 4 is a schematic diagram of concurrent data streaming in accordance with an aspect of the present invention.

FIG. 5 is a schematic diagram of reading multiple concurrent data streams with respect to multiple play outputs in accordance with an aspect of the present invention.

FIG. 6 is a flow diagram of an exemplary method that demonstrates concurrent data streaming in accordance with an aspect of the present invention.

FIG. 7 is a flow diagram of an exemplary method that facilitates verifying constant angular velocity (CAV) in accordance with an aspect of the present invention.

FIG. 8 is a flow diagram of an exemplary method that facilitates determining seek times in accordance with an aspect of the present invention.

FIG. 9 is a schematic block diagram of an exemplary communication environment in accordance with the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Accordingly, it is to be appreciated that various aspects of the subject invention can employ probabilistic-based and/or statistical-based classifiers in connection with making determinations and/or inferences in connection with the subject invention. For example, such classifiers can be employed in connection with utility-based analyses described herein. A support vector machine (SVM) classifier can be employed—an SVM generally operates by finding a dynamically changing hypersurface in the space of possible inputs. Other directed and undirected models/classification approaches include, e.g., naïve Bayes, Bayesian networks, decision trees, Hidden Markov Model (HMM), data fusion engine, neural network, expert system, fuzzy logic, or any suitable probabilistic classification models providing different patterns of independence can be employed. Classification as used herein also is inclusive of statistical regression that is utilized to develop models of priority.

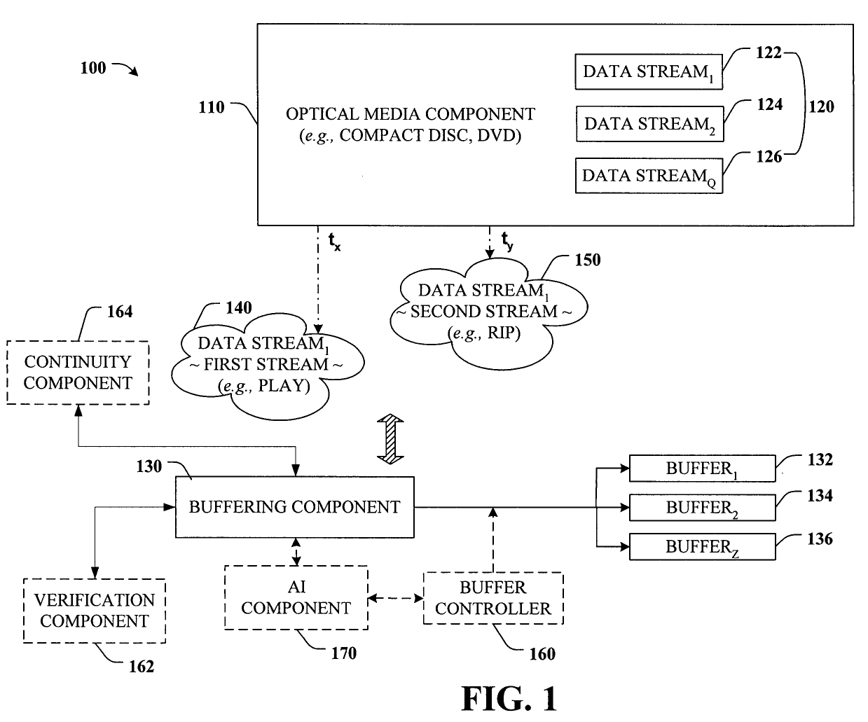

Referring now to FIG. 1, there is illustrated a general block diagram of a system 100 that facilitates concurrent data streaming from optical media (e.g., optical medium). The system 100 comprises an optical media component 110, examples of which include compact discs and DVDs. The optical media component 110 comprises one or more data streams 120 (e.g., individually DATA STREAM₁ 122, DATA STREAM₂ 124, and up to DATA STREAM_{Q} 126, where Q is an integer greater than or equal to one). The data streams 120 comprise any type of data such as, audio data for example. Audio data may include songs, sound recordings, voice recordings, music, books, seminars, meetings, and the like.

The optical media component 110 interfaces with a buffering component 130, such as a buffer operatively associated with and/or connected to an optical media drive (not shown). The optical media component 110 can be inserted into the optical media drive, which can then access and read the audio data located on the optical media component 110. As the data streams 120 are read from the optical media component 110, such data can be locally stored to the buffering component 130. The buffering component 130 can be employed to improve performance by holding information that is read from the disc so that is available to the system when needed in the near future. This improves performance of the optical media drive by reducing the number of optical head seeks and physical accesses to the actual disc.

The buffering component can initially have zero buffers upon its creation. However, when an operation (e.g., audio play mode) of one data stream is initiated, the buffering component can comprise at least one buffer. As shown in FIG. 1, the buffering component 130 comprises a plurality of buffers (e.g., at least one buffer) which facilitates concurrent streaming of data from a single compact disc, for example. Each of the plurality of buffers can be designated for particular functions as initiated by the optical media drive. For instance, when an audio play mode (real-time data stream read) is initiated by a user, BUFFER₁ 132 can be called to store the corresponding information relating to the relevant data stream 120 as it is being read during the audio play mode. Traditional systems and hardware do not permit a concurrent action to be performed once audio play has begun. However, according to one aspect of the present invention, the use of a second buffer allows a concurrent action, such as reading a second buffer to long-term storage, to be performed with respect to the same optical media component 110.

This is accomplished at least in part by verifying that the optical media drive can support the requested minimum data transfer rate (e.g. 176 KBps) for the client prior to allowing the operation to start, and by determining whether the buffers have sufficient capacities to cache the data during the play and record modes, respectively. Sufficient buffer capacity can involve buffer size (e.g., minimum buffer size of at least one buffer associated with at least one real-time data stream) with respect to each buffer employed to achieve reading more than one stream of data at any given time.

Recall that conventional audio/video systems permit one stream of data to be read at a time. In such conventional systems, a playback buffer temporarily stores about 10-30 seconds of data, depending on the model, to reduce the number of physical seeks made by the device; thereby mitigating interruption during playback. Anti-skip CD and/or DVD players typically employ this technology, as they are commonly made for hand-held use or installed in vehicles. Therefore, when the device is bumped, for example, causing the optical head to “lose” its place on the disc, the data can be read from the playback buffer rather than from the disc surface. This allows enough time for the optical head to seek back to its proper location on the disc surface so as to avoid interruption or “skips” in the data during playback. Thus, buffers can be critical to the successful operation of a device.

In the present invention, buffers are strategically employed to facilitate reading at least two streams of data concurrently from the disc without interrupting either stream. That is, one stream of data can be performing a first operation while a second operation is currently in progress with respect to a second stream of data. For this to occur without interruption to either stream of data, minimum buffer size requirements exist and are based at least in part upon the time it takes to perform two seeks (e.g., one seek for the second operation and another seek to go back to the first operation) as well as on the speed at which data can be read from the disc.

In other words, the playback buffer should have the capacity to store enough data to allow the following to occur:
(a) time for an optical head to seek back to a relevant section of data in connection with performing the second operation (e.g., ripping the disc);
(b) read the relevant section of data from the disc (e.g., related to the second operation); and
(c) time to seek forward to return to the relevant location in connection with the first operation
   without interrupting the first operation.

Moreover, the factors for reading at least two concurrent streams of data can be defined in the following manner:
B1—buffer size for first operation (e.g., playback) expressed in kilobits (Kb)
B2—buffer size for second operation (e.g., recording) expressed in Kb
T_{S}—seek time expressed in seconds (e.g., sec)
S—read speed expressed in kilobits per second (e.g., Kb/sec).

The read speed (S) and the seek time(s) typically are based on the type and quality of the drive; however, the two buffer sizes can vary for any given drive. If it is assumed that a second operation is not performed (e.g., thereby obviating the need for a second buffer), then the buffer size for the second operation (B2) can be 0 Kb. However, in order to ascertain whether more than one stream of data could be read at the same time during the first operation, the minimum buffer size for the first operation (B I) must be determined. Thus, to determine the minimum value of B1 that would allow the optical media drive to seek back and forth without actually performing the second operation (B2) from an alternate location, the following equation can be used:
if B2=0 Kb, B1=x Kb, Tₛ=t sec, S=z Kb/sec,
then B1=x Kb(z Kb/sec)*2*(t sec) (1)

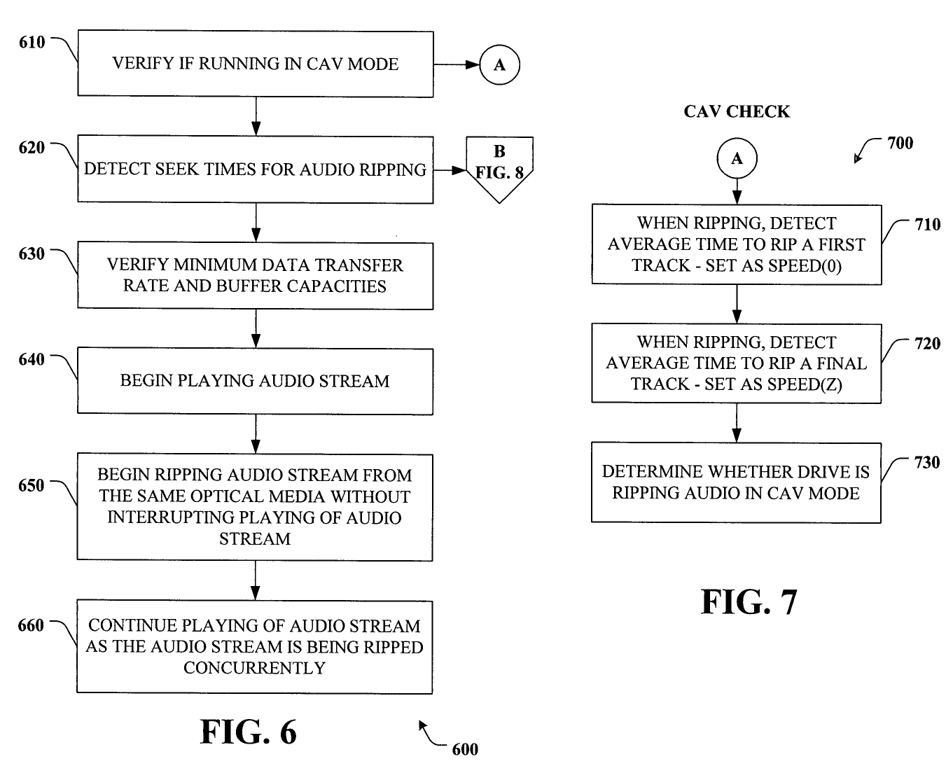

Therefore, the minimum buffer size for playback in this scenario is equal to the seek time for two seek operations multiplied by the read speed associated with the optical media. Additional algorithms can be devised based on these variables. Finally, the drive can also be assessed to determine whether concurrent data streaming is feasible for a given drive. The drive's capability involves detecting seek times across the disc as well as the average time it takes to read a section of data. This can also facilitate verification of whether the drive is operating in CAV (Constant Angular Velocity) mode. More discussion on this and other related topics is presented in connection with FIGS. 6-7 infra.

Moreover, the optical media drive can be made to constantly seek back and forth according to these algorithms, alternating the filling of each buffer (e.g., BUFFER₁ 132 and BUFFER₂ 134 up to BUFFER_{Z} 136, where Z is an integer greater than or equal to one), such that the optical media drive never reads the same sector or portion of the data stream 120 at the same time while concurrently playing and recording the data stream 120. Essentially, it appears as if the optical media drive is at two places at once on the optical media 110.

For instance, a song off of a compact disc is playing and as it is plays, sectors of the song are sequentially cached to the BUFFER₁ 132. The same song can be concurrently recorded to a hard drive (e.g., long term memory storage) by the optical media drive seeking back to the sectors of the song that have been already buffered during play (e.g., in BUFFER₁ 132). As the song is being concurrently recorded, the raw audio sectors are stored in the second buffer, such as BUFFER₂ 134 (e.g., long-term memory storage, hard disk drive). This seeking back and forth between playing and recording continues until the song finishes playing. At some time thereafter, the song finishes recording to the second buffer as well.

Conceptually, this can be viewed as two streams of the same audio data being read by the same optical media drive: a first stream 140 of data can start play at time tₓ for some amount of time in real time; and then at some later time t_{y}, a second stream 150 of the same data (e.g., same data source) can begin recording or ripping concurrently with the playing of the first stream in progress.

When maintaining at least two streams of audio data, the optical media drive is constantly seeking back and forth between the playing audio and the recording audio. Thus, seek times are a critical aspect to the concurrent data streaming. In order to seek back and forth between the playing and recording audio in time to mitigate interruption or delay in either mode, sufficient buffer capacity is necessary. As shown in FIG. 1, at least two buffers are involved for the at least two data streams. For example, one buffer can be utilized during play (e.g., playback) for temporary storage and another buffer can be employed to store the recorded audio data for long-term, future use.

Recall that as the audio data is played, it is transferred to a playback buffer, for example, for faster retrieval in the immediate future. This improves performance by mitigating the number of physical accesses to the disc. However, when concurrent recording of the audio data is desired, the optical media drive is typically required to access the surface of the disc and to seek the appropriate location of the audio data. Because such physical accesses to the disc can be costly in terms of time and speed and can ultimately diminish performance, the system 100 includes an optional buffer controller 160.

The buffer controller 160 is operatively coupled between the buffering component and the buffers themselves, or alternatively, interfaces between the optical media component and the buffering component. Other arrangements may be feasible so long as the buffer controller 160 maintains control over the buffers and can selectively choose which buffer to employ or access for any given function. This is important since in some cases, the cost of seeking and accessing the disc surface may be greater than simply accessing the playback buffer where at least a portion of the audio data has already been saved and is readily available.

Before accessing the disc to concurrently record the audio data being played, the buffer controller 160 can analyze whether it is more cost-effective to access the disc surface or the buffer which also contains the information. The cost or utility-based analysis can involve a threshold selected and/or be pre-programmed by the user whereby if the calculated cost to access the disc exceeds a threshold, then the system 100 is instructed to access the relevant buffer. In addition or alternatively, if the calculated cost to access the disc exceeds a calculated cost to access the relevant buffer, then the system 100 is instructed to access the relevant buffer. Otherwise, the drive is instructed to access the disc.

A similar utility-based analysis can be performed when initially recording audio data to a long-term memory store. In this case, the recording of the audio data is initiated before playing of the audio data. As the data is being transferred and saved in the memory store, a user may want to concurrently play the audio data from the beginning. Thus, a utility-based analysis can be performed to determine whether to access the previously saved (e.g., recorded) portions of audio data or to access the disc. Again, if it is more cost effective (e.g., compare to a threshold) to retrieve at least the saved portions of audio data from the memory store than to access the disc itself (e.g., original source), then the system 100 can be instructed to do so.

As a general matter, the buffer controller 160 can also determine which buffer to employ and when a buffer should be employed in order to facilitate the concurrent data streaming. Such determination may be based at least in part upon access time, seek times, size of desired audio data, buffer capacity, and rip speed.

In addition to the buffer controller 160, an optional verification component 162 can be coupled to the buffering component 130 and/or to the optical media drive (not shown) to facilitate determining whether the optical hardware device or drive is capable of supporting the concurrent data streaming. The verification component can examine the speed parameters of the hardware as well as the buffer capacity. If the verification component determines that concurrent data streaming is not feasible given the current hardware, then a notification can be sent to the system and/or to the user informing them of such. Subsequent attempts or requests to concurrently stream data can be responded to with an error-type message to notify the user that the current hardware does not meet required minimum data transfer rates (e.g., 176 KBps) for W streams of data and/or for the number of clients desiring to access such data (e.g., where W is an integer greater than or equal to one).

The system can also optionally include a continuity component 164 to facilitate concurrent recordation of a plurality of data streams in parallel from the optical medium. The continuity component can analyzes a subset of the data streams and dynamically order reading of respective data streams of the subset to mitigate potential stream break-up thereby facilitating continuous streaming of data. Any suitable scheme (e.g., round robin, priority-based, volatility-based, size-based, throughput-based . . . ) or combination thereof for ordering the data streams to be read can be employed in connection with the subject invention, and all such schemes are intended to fall within the scope of the hereto appended claims. Moreover, the continuity component can analyze a subset of the data streams and dynamically diagnose and/or prognose potential starvation of any of the data streams, and take remedial action to mitigate starvation. Prognosis refers to predicting a future state (e.g., via inference, probabilistic-based utility analysis, statistical-based analysis, historical trend analysis, data fusion analysis, . . . ) of the system 100 and/or events and/or variables impacting the system.

Finally, the system 100 can optionally include an AI component 170. The AI component 170 can comprise classifiers such as for example a Bayesian classifier, a support vector machine, and/or other type of classifier and/or other non-linear training system(s). The AI component 170 can facilitate performing inferences and/or utility-based determinations in accordance with the subject invention. For example, the AI component 170 can perform a utility-based analysis in connection with the recordation and playback and can infer when to initiate recordation.

Various extrinsic factors (e.g., state of user, historical information, type of information received . . . ) can be employed in connection with the inference/analysis. For example, correctly inferring that a recordation is about to commence after play has begun and concurrently therewith can optimize effecting minimal interruption mode and mitigate loss of recordation and playback fidelity. Additionally, factoring in the cost of making an incorrect inference can further facilitate utility of the invention. The AI component 170 can be trained explicitly as well as implicitly to facilitate optimal employment of concurrent recordation and playback (e.g., concurrent data streaming) in accordance with the subject invention. The AI component 170 can be operatively connected to the buffering component 130 and/or the buffer controller 160 and can perform inference and utility-based determinations with respect to the functionality of the respective components.

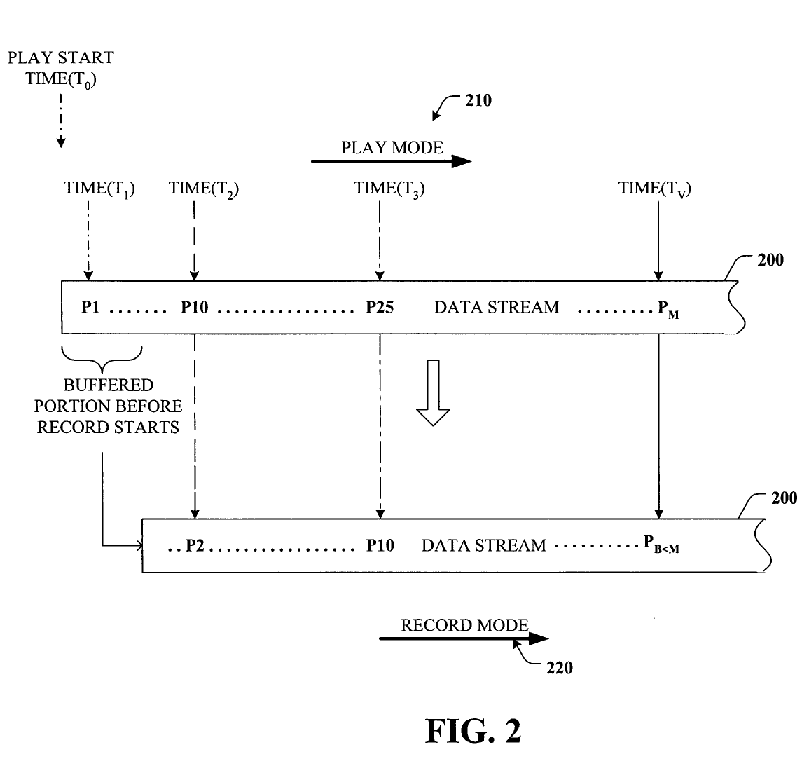

Turning to FIG. 2, there is depicted a schematic illustration of an exemplary DATA STREAM 200 existing on optical media (not shown) in play mode 210 and record mode 220 concurrently at various times. In addition, FIG. 2 demonstrates that the optical media drive can essentially access audio data, for example, from two different places on the optical media at about the same time by seeking back and forth and buffering between them.

For instance, the data stream 200 can be divided into audio sectors (e.g., P1 and up to P_{M} where M is an integer greater than or equal to one) such that each audio sector comprises a known amount of information (e.g., 2352 bytes, 300 KB, 2 MB, etc.). The audio sectors correspond to various positions of the data stream 200. For example, imagine that the data stream corresponds to a music track on a compact disc. Audio sector P1 may correspond to a first few seconds of the music, sector P10 may correspond to a middle segment of the music, and sector P_{M} may correspond to some later segment of the music. The optical media drive must be able to read audio data from the optical media at a minimum speed of 1× and/or with a guaranteed minimum data transfer rate of about 176 KBps with respect to non-optical media with the same data (e.g., 176 KBps is the AudioCD data transfer rate).

As shown in FIG. 2, the data stream 200 has begun in the play mode 210 (e.g., real-time data stream) at TIME(T₀) as initiated by the user. At about TIME(T₁), audio sector P1 can be read to a buffer and played. Once some sufficient amount of audio data has been buffered, a call can be made to record the data stream 200 concurrently while it is being played if such action is desired. Thus, a previously played portion, segment or sector of the data stream 200 can be recorded while a later portion, segment or sector of the data stream 200 is being read and transferred to a buffer in play mode 210. This is further illustrated at TIME(T₂), wherein the audio data up to about sector P10 has played and data up to about audio sector P2 has been recorded to a long-term memory store. Likewise, at TIME(T₃), audio sector P25 has been read and up to about P10 has been recorded.

In this example, the record mode stream 220 occurs at a slower rate than the playback audio stream 210. Thus, at TIME(T_{V}), further sectors of audio data (e.g., up to about P_{M}) have been accessed and recorded at a transfer rate which does not exceed that of the play mode. In an actual test case, it was demonstrated that audio data could be ripped (e.g., non-real-time data stream) while being listened to (e.g., real-time data stream) from a drive that was able to read the audio data at a speed of 1.25×.

Play of the audio data stream 200 can continue until TIME(T_{V}) or can be terminated earlier as desired by the user. Similarly, recording can continue until the end of the audio data stream is reached. However, if play is terminated prematurely or before the end of the data stream is reached, then the recording can still proceed without interruption or delay. Although this example depicts the record mode stream 220 reading the data at a slower rate than the playback mode stream 210, it should be appreciated and understood that the two data stream pointers can cross each other without interfering with one another's operation. Furthermore, this also applies to any two or more data streams (e.g., real-time data stream and/or non-real-time data stream or any combination thereof) performing operations concurrently with the other(s).

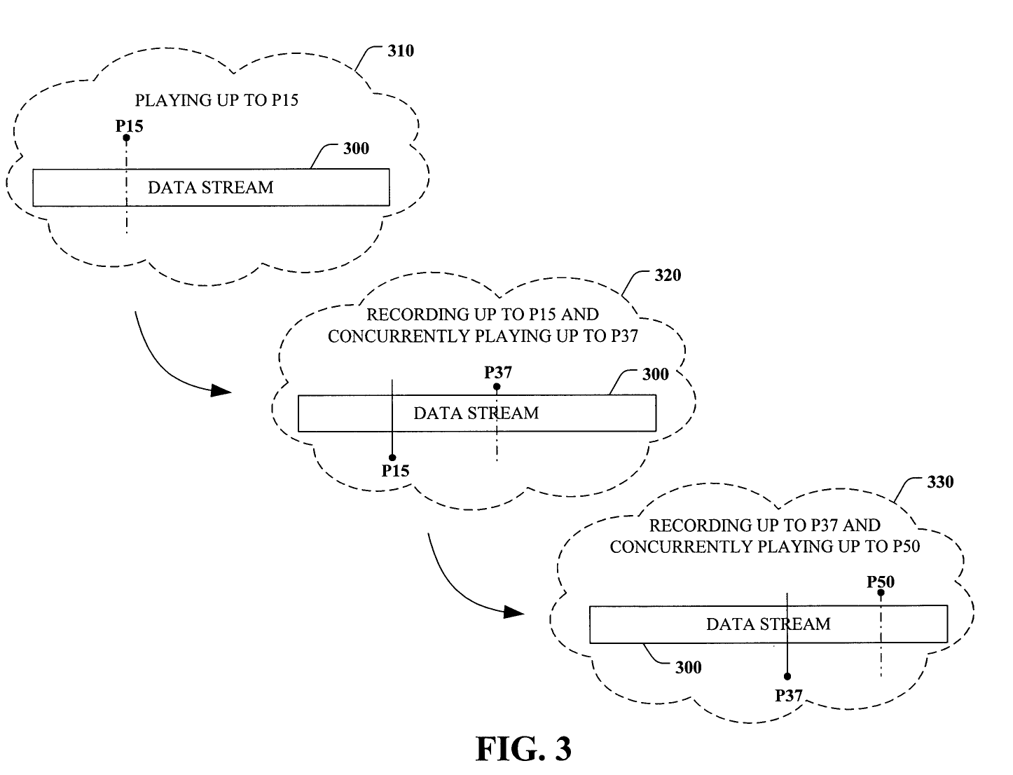

FIG. 3 further elaborates on the concepts discussed above in FIG. 2. In particular, FIG. 3 illustrates a schematic diagram of a data stream 300 in a series of “snapshots” 310, 320, and 330 taken during concurrent playing (e.g., real-time data stream) and recording (e.g., non-real-time data stream) of audio data. The data stream 300 can be divided into sectors or segments whereby each sector or portion thereof can be identified by a numbered position. For illustrative purposes, positions associated with the real-time data stream are indicated by a dashed line; and positions associated with the non-real-time data stream are indicated by a solid line.

In the first snapshot 310, the data stream 300 is being played up to about position P15 of the data stream. Position P15 may relate to an audio sector or time segment of the data stream such as the 1:02 position of the data stream 300. The next snapshot 320 demonstrates a subsequent period of time. In particular, the data stream 300 is now recording up P15 and at the same time, is playing up to position P37. Finally, the third snapshot 330 depicts the data stream 300 being ripped up to P37 while it is playing up to P50, which may be near the end of the data stream.

The converse may apply as well. That is, if recording is initiated before play, it is also feasible for earlier portions of the data stream to be played from same optical media as it was previously recorded therefrom. By way of example, snapshot 310 can be described as recording up to P15. Subsequently, snapshot 320 can be described as playing up to P15 while concurrently recording from P16 up to P37, and so on.

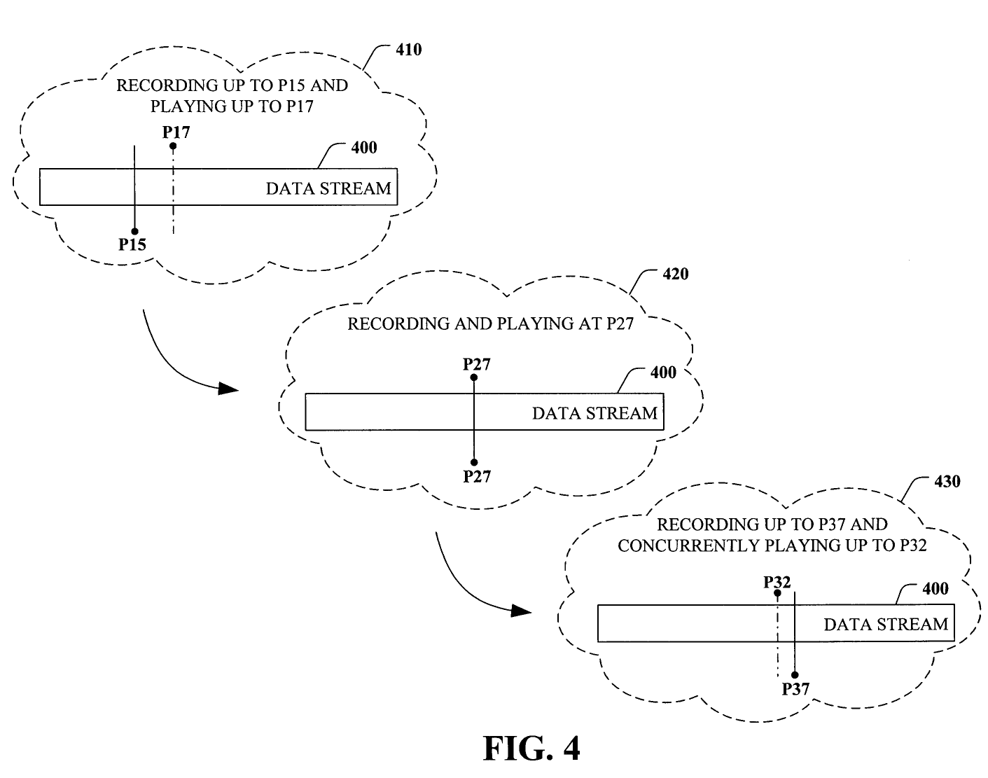

In addition, as shown in FIG. 4, it is also possible for the playback (e.g., real-time data stream) and the recording (e.g., non-real-time data stream) positions to swap positions relative to one another. In a first snapshot 410, a data stream 400 is being recorded up to about position P15 in the data stream, and playback occurring up to about position P17 in the data stream (as in FIG. 3 at 320). The next snapshot 420 demonstrates a subsequent period in time where both the recording and playback operations are reading data from the same location (P27) in the stream. Finally, the third snapshot 430 depicts the data stream being recorded up to position P37 in the data stream, and playback occurring up to about position P32 in the data stream.

The two recording and playing data streams can be maintained concurrently as long as all the real-time data stream requirements (the playback in this example) are met with some data rate remaining for use by the non-real-time data streams (the recording in this example). By definition, if the available read speed (S) is greater than the speed required for a single real-time consumer, then a user can (with sufficient buffering) perform both a real-time and non-real-time operation simultaneously by greatly limiting the data rate of the non-real-time operation. However, such a buffer might be the size of the entire medium.

The variables in keeping one real-time data stream (e.g., audio playback) and one non-real-time data stream (e.g., long-term audio storage) going are the real-time data stream's buffer size (B₁), the non-real-time data stream's buffer size (B₂), the device's applicable seek times (T_{S1}, T_{S2}), and the device's applicable data rate for each buffer (S₁ and S₂). As seek times and data rates are typically not selectable on devices, it becomes a unique challenge to determine the minimal buffers sizes B₁ and B₂.

Since the data rates (S₁,S₂), seek times (T_{S1},T_{S2}), buffer size (B₁), and the required data rate for the real-time data stream (S_{R1}) are all known, the maximum size of the remaining buffer to be filled can be found using the following equation:
B₂/S₂=((B₁/S_{R1})−(B₁/S₁))−(T_{S1}+T_{S2}) (2)

One alternative view of this equation is to first attempt to determine the amount of “excess” bandwidth that exists after ensuring that all real-time data streams can be satisfied for a given buffer size. To do this, it is useful to define P as the percent of time the drive would be in use if it were only handling the first stream (with seeks). This percentage of use can be written as (1−((Time to use B₁)−(Time to fill B₁)−(Time to seek back and forth))), and the unit of time is (Time to use B₁). Written symbolically, this becomes:
P=1−(((B₁/S_{R1})−(B₁/S₁)−(2*T_{S}))/(B₁/S_{R1})) (3)

Considering the abilities of the drive in terms of its percentage use is particularly useful, as it allows extrapolation of the above algorithms to multiple streams. It is logically clear that multiple real-time streams may then be supported on a given device so long as the sum of the percentage of use does not exceed 100%. Any remaining percentage, while possibly not sufficient to support real-time data streams, can then still be used for a non-real-time data stream.

In some cases, the buffer may be the size of the entire disc in order to achieve the concurrent data streaming. Finally, the drive's ripping capability can also be assessed to determine whether concurrent data streaming is feasible for a given drive. The drive's ripping capability includes detecting seek times for audio ripping across the disc as well as the average time it takes to rip a first track, which can also facilitate verification of whether the drive is operating in CAV (Constant Angular Velocity) mode. More discussion on this and other topics can be found with respect to FIGS. 6-8, infra.

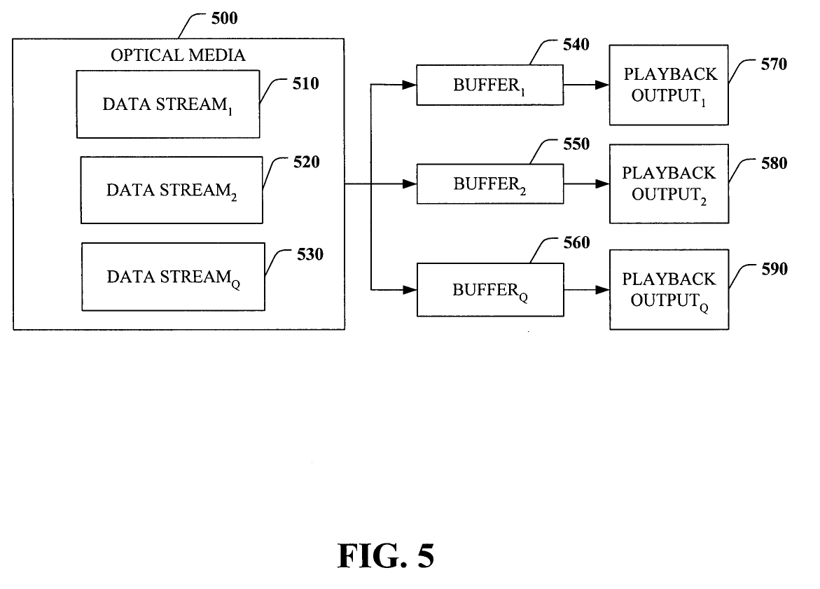

Referring now to FIG. 5, there is illustrated a schematic block diagram of an additional aspect of the present invention that facilitates concurrent data streaming. In particular, with the use of more than one buffer, more than one data stream can be read from the same optical media and played at the same time via more than one playback output.

As shown in FIG. 5, an optical media component 500 is depicted as comprising a plurality of data streams defined as DATA STREAM₁ 510, DATA STREAM₂ 520, and DATA STREAM_{Q} 530. Each stream of data is associated with a buffer. For example, BUFFER₁ 540, BUFFER₂ 550, and BUFFER_{Q} 560 are designated for playback which means that as each data stream is being played concurrently with the others, their respective buffers are employed to cache the data as it is being read. As a result, multiple data streams can be played at once. For example, track 1 from a compact disc can begin play at time tₓ. Shortly after track 1 begins play, the user can initiate track 3 to play at time t_{y} without disruption or interruption to track 1. In this scenario however, multiple playback outputs (e.g., PLAYBACK OUTPUT₁ 570, PLAYBACK OUTPUT₂ 580 . . . up to PLAYBACK OUTPUT_{Q} 590) are operatively coupled to the optical media drive (not shown) to allow for multiple songs to be played and listened to at about the same time. This can be particularly advantageous when wanting to hear different tracks from a single compact disc throughout one's home or place of business. For instance, an upbeat music track can be played in the pool area whereas a slower tune can be played in the living room.

Various methodologies in accordance with the subject invention will now be described via a series of acts. It is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Referring now to FIG. 6, there is illustrated a flow diagram of an exemplary method 600 that facilitates concurrent data streaming from the same optical media. The method 600 involves verifying that the relevant optical drive is running in CAV (constant angular velocity model) at 610. CAV refers to a disk driving scheme in which the angular velocity of the disk is kept constant. That is, the linear velocity of the disk is larger when reading or writing the outer tracks. Further discussion of CAV checks and their significance can be found below in FIG. 7.

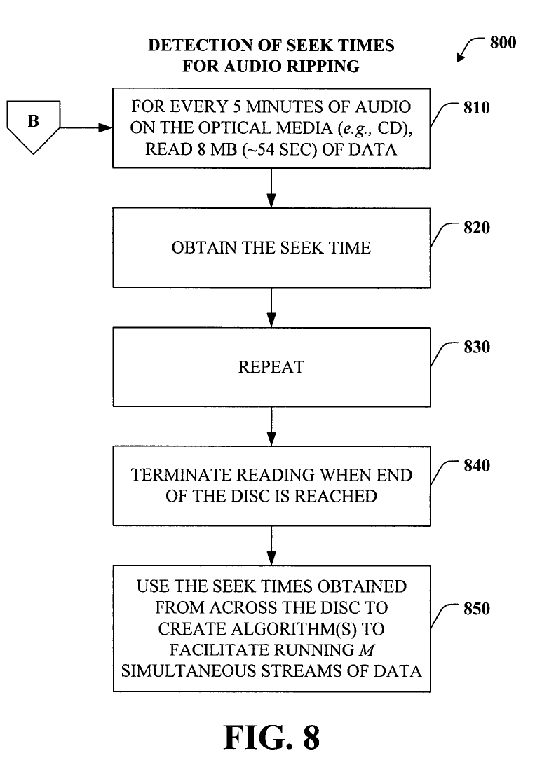

At 620, the method 600 also involves detecting seek times for audio ripping to determine seek times across the disc. This can be important for a number of reasons. In particular, recall that the optical media drive is seeking back and forth between two points of a data stream. A first point can represent a later position on the data stream in play mode and a second point can represent an earlier position on the data stream in record mode. Hence, the media drive must seek back and forth between various points on the data stream in order to concurrently play and record the stream without delay. Therefore, if the seek times across the disc are previously determined, then they can be used to facilitate concurrent data streaming. One exemplary process of detecting seek times for audio ripping is discussed, infra, with respect to FIG. 8.

Given the speed of the media drive at the start of the disc and the knowledge that speed will either increase or stay about the same as one seeks to the end of the disc, an algorithm to maintain two streams of audio data running can be readily devised in accordance with the present invention. All current hardware can maintain a ripping speed of at least 1× today. Moreover, most current-generation hardware is able to rip audio data streams at speeds over 30×. Even rip speeds just barely over 1× can be shown to support multiple data streams (e.g., listening and ripping) simultaneously and/or at least concurrently with sufficient buffering.

Moving on to 630 in FIG. 6, the media drive's guaranteed minimum transfer rate as well as the capacities of at least two buffers employed during the concurrent data streaming can be verified at this time. In some cases, a plurality of clients can access the optical media drive in order to play and/or record therefrom. Thus, a guaranteed minimum data transfer rate can be established to ensure that each client can readily experience concurrent data streaming without interference from either mode.

The at least two buffers utilized with respect to the present invention should be of sufficient size in order to allow a recording of the audio data stream even after it has begun playing. In particular, a portion of the audio data stream is read and saved in a first buffer so that play can continue while simultaneously recording earlier portions of the data stream to a second buffer or memory store. The second buffer saves a different portion (e.g., earlier portions) of the data stream during the recording process.

In practice, for example, a first buffer can be designated for playback and a second buffer can be designated for ripping. Imagine that an optical media player is playing audio from a newly-inserted compact disc. The user decides to rip the track. Instead of restarting the track in order to record it from the media player to the hard disk drive, the user can continue to listen to the audio while it is being ripped to the hard disk drive. That is, the user can continue to listen to the audio without interruption even after he has initiated the rip to a long-term storage device.

Still referring to FIG. 6, playing of an audio data stream can commence as desired by the user at 640. For instance, the audio data stream can be an audio clip from a DVD. As the user continues to listen to the audio clip, ripping or recording of the same clip can begin at 650, whereby there are effectively two streams of data that are running concurrently with respect to each other, irrespective of their relative positions within the clip. At 660, the audio clip continues to play concurrently with the recording of such clip.

Alternatively or in addition, a plurality of tracks can be played at about the same time such that each track is directed to a different playback output—operatively connected to the optical media drive. Likewise, a plurality of different audio tracks can be recorded at about the same time to a long term storage device with or without one of the plurality of tracks being played during such recording. As can be seen, a myriad of alternative arrangements are possible depending on the user's desires and objectives.

Turning now to FIG. 7, there is a flow diagram of an exemplary method 700 of checking to determine whether an optical media drive is operating in CAV mode. Having this information in hand facilitates creating algorithms to keep at least two streams of audio data running concurrently since the drive's speed influences seek times for playback as well as for ripping.

The method comprises detecting an average time to rip a first audio track on an optical media component at 710. This value can be set as SPEED(0). Next, at 720, an average time to rip a final audio track on the optical media component can be detected. This value can be set as SPEED(Z), where Z is an integer greater or equal to one. Finally, by using the two measurements, SPEED(0) and SPEED(Z), it can be determined whether the drive is ripping in CAV mode. Specifically, if the SPEED(0) value is greater than speed(Z), then the drive is ripping in CAV mode. However, if the drive does not appear to be ripping in CAV mode, then it may not be suitable to carry out the concurrent data streaming as described hereinabove.

CAV checks are not required, however. If the audio ripping capability of the drive has already been cached, then it can be broken down and saved as SPEED(cached) and SEEK TIMES(cached). The average time to rip a first audio track on the optical media can be obtained and set as SPEED(0) as described above. If the SPEED(0) is within 10% of SPEED(cached), then the SPEED(cached) is correct. However, if the SPEED(0) is greater than SPEED(cached), then SPEED(0) should be used. Finally, if the SPEED(0) is less than SPEED(cached), then the current disc is probably dirty and should be cleaned before proceeding. Alternatively, when a lower than expected data rate is experience for a given real-time data stream (e.g., SPEED(0) is less than SPEED(cached)), one solution involves reducing dynamically the amount of time the non-real-time data stream has for filling its own buffer (e.g., sacrifice non-real-time buffering speed for the real-time buffer dynamically).

Referring now to FIG. 8, there is a flow diagram of an exemplary method 800 that facilitates detecting seek times for audio ripping. The method 800 comprises reading about 8 MB (e.g., 54 seconds), for example, of audio data every 5 minutes beginning from the start of the disc (at 810). Other increments of time can be utilized as well as long as it is sufficient to gain characteristic read performances across the optical media. In addition, the method is not limited to 8 MB of data. Any amount of data can be chosen that is suitable to flush the drive's buffer of previous sectors to ensure that the drive is actually seeking. In other words, the amount of data employed should be sufficient to clear the drive's internal media cache. It is to be appreciated that the subject invention is not intended to be limited to this particular exemplary implementation to ensure occurrence of a seek. Any suitable command sequence scheme (e.g., SYNCHRONIZE_CACHE, use of a special Force Unit Access bit in the READ command) can be employed to ensure a seek occurs, and such schemes are intended to fall within the scope of the hereto appended claims.

At 820, the seek time from the current position to all other 5-minute positions on the optical media can be obtained. This is important as many devices have different seek times when seeking to a location logically forward on the disc versus seeking to a location logically backwards on the disc.

The method 800 can be repeated at 830 (e.g., repeat at 810 and 820) until the end of the disc is reached and read at 840. At about 850, the seek times obtained for each five-minute interval of data across the disc can be used to create algorithms in order to facilitate running W simultaneous and/or concurrent streams of data (e.g., W is an integer greater than or equal to one).

In accordance with the present invention as described hereinabove, the following pseudo-code can be employed to carry out at least one aspect of the invention. The exemplary pseudo-code is as follows:

Check if already cached the drive's audio ripping capability.
If yes, save as Speed(cached) and SeekTimes(cached)[ ].

When ripping, detect the average time it takes to rip the first track, Speed(0).

CAV Checks:

When ripping, detect the average time it takes to rip the final track, Speed(N).

Check to see if drive is ripping audio in CAV mode. This would mean that Speed(0) is greater than Speed(N), according to a formula which you can devise for speed in CAV mode.

If Speed(0) is within 10% of Speed(cached), it is correct.

If Speed(0) is greater than Speed(cached), use Speed(0).

If Speed(0) is less than Speed(cached), the current disc is probably dirty.

Detection of seek times for audio ripping:

For every five minutes of audio existing on the disc, I=={0,5,10, . . . N} do:
For J=={0,5,10, . . . N}// because want seek times both ways
   Read 8 MB(*) of audio data (˜54 seconds) from minute I
   Save tickcount (I,J)
   Read one audio sector from minute J
   Get tickcount, subtract tickcount(I,J), save new value as tickcount(I,J)
   Read remainder of 8 MB of audio data from minute J

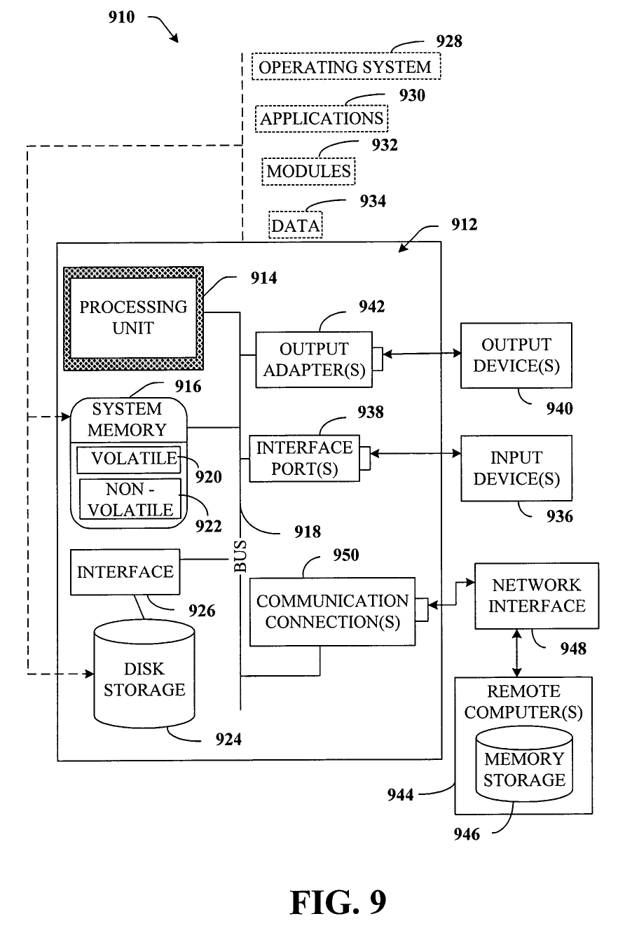

In order to provide additional context for various aspects of the present invention, FIG. 9 and the following discussion are intended to provide a brief, general description of a suitable operating environment 910 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 910 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 9, an exemplary environment 910 for implementing various aspects of the invention includes a computer 912. The computer 912 includes a processing unit 914, a system memory 916, and a system bus 918. The system bus 918 couples the system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/nonremovable, volatile/nonvolatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the present invention can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates utilizing an optical medium, comprising:
a component that provides concurrent recordation of and playback from an optical medium, the playback starting at time (tₓ) and the recordation starting at time (t_{y}), wherein tₓ≠t_{y}.

2. The system of claim 1, recordation refers to a non-real-time data stream.

3. The system of claim 1, playback refers to a real-time data stream.

4. The system of claim 3, the component dynamically adjusts required data rates for the real-time data stream.

5. The system of claim 1, comprising a verification component that determines data transfer capabilities of the optical medium.

6. The system of claim 5, the data transfer capabilities comprising at least one of minimum data transfer rate, read speed, burn speed, seek times and buffer size.

7. The system of claim 1, the optical medium comprising at least one of: a compact disc and a digital video disc (DVD).

8. The system of claim 1, the optical medium comprising audio data.

9. The system of claim 1, comprising at least one buffer that holds information from playback of the medium.

10. The system of claim 9, the at least one buffer has a minimum buffer capacity, the minimum buffer capacity is a function of read speed and at least one seek time.

11. The system of claim 1, further comprising a buffer controller that controls at least one of creation and use of at least one buffer.

12. The system of claim 11, the buffer controller performs a utility-based analysis in connection with buffer access.

13. The system of claim 12, the utility-based analysis based in part on a probabilistic-based determination of cost associated with saving data to the buffer.

14. The system of claim 12, the utility-based analysis based in part on a probabilistic-based determination of cost associated with retrieving data from the buffer.

15. The system of claim 1, the optical medium has a guaranteed minimum data transfer rate.

16. The system of claim 15, the guaranteed minimum data transfer rate is at least about 176 KBps.

17. The system of claim 1, comprising a component that provides concurrent playback of a plurality of data streams from the optical medium.

18. The system of claim 17, the data streams comprising audio data.

19. The system of claim 17, the plurality of data streams comprising at least a first data stream and at least a second data stream, such that the first data stream starts playing at tₓ and the second data stream starts playing at t_{y}, wherein tₓ≠t_{y}.

20. The system of claim 1, comprising a continuity component that provides concurrent recordation of a plurality of data streams in parallel from the optical medium.

21. The system of claim 20, the plurality of data streams comprising at least a first data stream and at least a second data stream, such that the first data stream starts recording at tₓ and the second data stream starts recording at t_{y}, wherein tₓ≠t_{y}.

22. The system of claim 20, the continuity component analyzes a subset of the data streams and dynamically orders reading of respective data streams of the subset to mitigate stream break-up.

23. The system of claim 20, the continuity component analyzes a subset of the data streams and dynamically prognoses potential starvation of any of the data streams, and takes remedial action to mitigate the starvation.

24. The system of claim 23, the continuity component employs a probabilistic-based utility analysis in connection with providing a prognosis.

25. A method of utilizing optical media comprising:
initiating a first operation from the optical media at time tₓ; and
initiating at least a second operation from the optical media at time t_{y} while the first operation is currently in progress, wherein tₓ≠t_{y}.

26. The method of claim 25, the first operation comprising reading a real-time data stream.

27. The method of claim 25, the at least a second operation comprising one of reading a real-time data stream and a non-real-time data stream.

28. The method of claim 26, transferring the real-time data stream to a first buffer for temporary storage at a sufficient rate to allow the data stream associated with the second operation to transfer to a second buffer without interrupting the first operation.

29. The method of claim 28, comprising:
before the second operation begins, determining whether a calculated cost of accessing the optical media exceeds any one of the following: a threshold and a calculated cost of retrieving the data stored in the first buffer; and
retrieving the data from the first buffer during the second operation when the calculated cost of accessing the optical media exceeds at least one of the threshold and the cost of retrieving the data from the first buffer.

30. The method of claim 25, comprising verifying data transfer capabilities of an optical hardware device that is employed to run the optical media.

31. The method of claim 30, verifying the data transfer capabilities comprising performing at least one of the following:
checking the optical hardware device to determine whether it is running in constant angular velocity (CAV) mode;
determining at least one of seek times and read performance across the optical media for reading a non-real time data stream from the optical media; and
determining whether minimum buffer requirements are satisfied.

32. The method of claim 31, determining read performance across the optical media to facilitate ascertaining the optical hardware device's ability to read the optical media comprising:
reading at least a first amount of data from the optical media such that the device's internal media cache is not concurrently caching the first amount of data when the reading of the first amount of data starts; and
skipping ahead an increment of time that is sufficient to gain characteristic read performances across the optical media and repeat reading the amount of data from the optical media until substantially all of the optical media is read.

33. The method of claim 32, the first amount of data being about 8 MB.

34. The method of claim 32, the increment of time being about 5 minutes.

35. The method of claim 32, wherein each amount of data is substantially equal in size.

36. The method of claim 32, wherein the amount of data is determined based at least in part upon the device's internal buffer size.

37. The method of claim 31, determining seek times across the optical media to facilitate ascertaining the optical hardware device's ability to seek on the optical media comprising:
dividing the optical media into a number of sections, the number of sections comprising at least a first section and at least a second section, such that the device's internal cache does not pre-cache the data from the second section when told to read the start of the first section; and
for all pairs of sections comprising any two sections, ensuring the device is reading from the first section and then causing the drive to seek to the second section to gain characteristic seek performances across the optical media.

38. The method of claim 37, wherein all sections are of substantially equal size.

39. The method of claim 37, wherein the section size is determined based at least in part upon the device's internal buffer size.

40. The method of claim 37, wherein ensuring to read from the first section comprises reading an amount of data larger than the device's internal buffer size from some section other than the first and second sections.

41. The method of claim 37, wherein ensuring to read from the first section comprises sending a READ10 command with a force unit access (FUA) bit set to one.

42. The method of claim 37, wherein causing the drive to seek to the second section comprises using a READ10 command with a force unit access (FUA) bit set to one.

43. The method of claim 37, wherein causing the drive to seek to the second section comprises using a SEEK command.

44. The method of claim 37, wherein the section size is about 5 minutes.

45. The method of claim 37, wherein ensuring to read from the second section comprises reading an amount of data larger than the device's internal buffer size from the first section.

46. The method of claim 31, the minimum buffer requirements being a function of read speed and seek times.

47. A method of utilizing optical media comprising:
starting to read at least a first real-time data stream from the optical media at time tₓ; and
starting to read at a least a second real-time data stream from the optical media concurrently with the first real-time data stream at time t_{y}, wherein tₓ≠t_{y}.

48. The method of claim 47, the first data stream being played via a first playback output and the second data stream being played via a second playback output.

49. A method of utilizing optical media comprising:
starting to read at least a first non-real-time data stream from the optical media at time tₓ; and
starting to read at a least a second non-real time data stream from the optical media concurrently with the first non-real-time data stream at time t_{y}, wherein tₓ is not equal to t_{y}.

50. A data packet adapted to be transmitted between two or more computer processes facilitating reading multiple concurrent data streams from optical media, the data packet comprising:
information associated with reading a real-time data stream from the optical media at time tₓ and concurrently reading a non-real-time data stream from the optical media at time t_{y}, wherein tₓ≠t_{y}.

51. A computer-readable medium having stored thereon the following computer executable components:
a component that provides for concurrently reading a non-real-time data stream from optical media starting at t_{y} and reading a real-time data stream from the optical media starting at tₓ, wherein tₓ≠t_{y}.

52. A system that facilitates employment of optical media, comprising:
means for starting to read at least one real-time data stream from the optical media at time tₓ; and
means for starting to read one or more non-real-time data streams from the optical media concurrently while it is playing at time t_{y}, wherein tₓ≠t_{y}.

53. A recording system, comprising:
a component that provides concurrent recordation of and playback of respective media from an optical medium, the playback starting at time (tₓ) and the recordation starting at time (t_{y}), wherein tₓ≠t_{y}; and
an artificial intelligence (AI) component that performs a utility-based analysis in connection with the recordation and playback.

54. The system of claim 53, the AI component comprising a classifier.

55. The system of claim 53, the AI component inferring when to initiate recordation.

56. The system of claim 53, further comprising a verification component that determines data transfer capabilities of the optical medium.

57. The system of claim 53, the data transfer capabilities comprising at least one of minimum data transfer rate, read speed, burn speed, seek times and buffer size.

58. The system of claim 53, the AI component comprising at least one of: a support vector machine (SVM), a naïve Bayes model, a Bayesian network, a decision tree, a Hidden Markov Model (HMM), neural network, data fusion engine.
